(19) United States
(12) Patent Application Publication
(10) Pub. No.: US 2020/0109730 A1
(43) Pub. Date: Apr. 9, 2020

(54) FURNITURE ASSEMBLY APPARATUS AND SYSTEM

(71) Applicant: Kerri Ruth Hall, King, NC (US)

(72) Inventor: Kerri Ruth Hall, King, NC (US)

(21) Appl. No.: 16/591,135

(22) Filed: Oct. 2, 2019

Related U.S. Application Data
(60) Provisional application No. 62/740,543, filed on Oct. 3, 2018.

(51) Int. Cl. F16B 12/10

(52) U.S. Cl. CPC F16B 12/10; A47B 96/20

(57) ABSTRACT

In preferred embodiments, the invention is an apparatus for coupling furniture components and a system for assembling furniture from subassemblies that may be purchased and shipped individually. The apparatus and system may be optimized for low cost shipping and ease of assembly. As a non-limiting example, subassemblies may couple together at joints comprising interlocked stacks of plates held in place by a beveled pin. If a subassembly breaks during normal use, the pins may be withdrawn and the broken subassembly may be removed and replaced without having to replace the entire piece of furniture. Additionally, the system may include methods of packing subassemblies for shipping so as to reduce the physical size of the shipping package as much as possible.

### CROSS REFERENCES TO RELATED APPLICATIONS

This Non-Provisional application claims, under 35 U.S.C. section 120, the benefit of the Provisional Application 62/740,543, filed Oct. 3, 2018, Titled “FURNITURE ASSEMBLY APPARATUS AND SYSTEM” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The furniture industry has lacked innovation—this includes upholstered pieces, un-upholstered pieces, chairs, sofas, modular pieces, cabinets, outdoor furniture, sofa sleepers, bed frames, platform beds, tables, etc. For many years, this type of furniture was fully constructed and shipped to the end consumer via a retailer. This has required the consumer to purchase product from the retailer in order to get the furniture into the consumer's desired location such as their office or home. It requires the retailer to deliver their furniture or take a truck or trailer to the retailer to pick up the furniture. Due to the size of most upholstered pieces, passing them through doorways or stairwells has also been a problem to contend with. Buying trends of consumers are changing significantly. There have also been a substantial number of furniture retail stores closing. We see a larger number of people purchasing furniture online from various E-tailers such as Amazon or Wayfair. Most of these products are shipped via freight trucks to the end consumer. This usually requires at least 2 people to deliver the product. This also requires the purchaser to be home upon delivery of their products.

The furniture industry has failed to address the consumer's life's mishaps in designing most of their products. If a customer's pet for instance would chew on a part of a sofa, the piece has to be replaced or pay for a costly reupholstery repairs. It can also be very difficult for a consumer to move large pieces of furniture.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1A is a top view of the first comb.

FIG. 1B is an isometric view of the first comb.

FIG. 1C is a front view of the first comb.

FIG. 1D is a side view of the first comb.

FIG. 2A is a top view of the second comb.

FIG. 2B is an isometric view of the second comb.

FIG. 2C is a front view of the second comb.

FIG. 2D is a side view of the second comb.

FIG. 3A is a top view of the conical peg.

FIG. 3B is an isometric view of the conical peg.

FIG. 3C is a front view of the conical peg.

FIG. 3D is a side view of the conical peg.

FIG. 4A is a top X-ray view of the furniture assembly apparatus illustrating the coupling of the first comb, the second comb, and the conical peg.

FIG. 4B is an isometric X-ray view of the furniture assembly apparatus illustrating the coupling of the first comb, the second comb, and the conical peg.

FIG. 4C is a front X-ray view of the furniture assembly apparatus illustrating the coupling of the first comb, the second comb, and the conical peg.

FIG. 4D is a side X-ray view of the furniture assembly apparatus illustrating the coupling of the first comb, the second comb, and the conical peg.

FIG. 5 is a view of the assembled sofa detailing mechanism positions.

FIG. 6 is a view of the assembled sofa in a deconstructed state.

FIG. 7 is a detail view of the assembled sofa illustrating the area designated as 7 in FIG. 6.

FIG. 8 is an exploded view of the sofa illustrating positions of the combs and conical pegs.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” refers to top and “lower” refers to the bottom. As a non-limiting example, the upper end of a vertical shaft is the top end of the vertical shaft.

As used herein, “align” refers to the placement of two or more components into positions and orientations which either arranges the components along a straight line or within the same plane or which will allow the next step of assembly to proceed. As a non-limiting example, the next step of assembly may be to insert one component into another component, requiring alignment of the components.

As used in this disclosure, an “aperture” is an opening in a surface. Aperture may be synonymous with hole, slit, crack, gap, slot, or opening.

As used in this disclosure, a “cone” is a surface that is generated by rotating a triangle around one of the legs of the triangle. If a line that is perpendicular to the base and is drawn from the center of the base goes through the vertex of the triangle then the cone is called a right cone. A cone is a type of quadric surface. The cone is a pyramid with a circular base.

As used in this disclosure, the word “correspond” indicates that a first object is in some manner linked to a second object in a one to one relationship or that one or more properties shared by two or more objects match, agree, or align within acceptable manufacturing tolerances.

As used herein, the words “couple”, “couples”, “coupled” or “coupling”, refer to connecting, either directly or indirectly, and does not necessarily imply a mechanical connection.

As used in this disclosure, a “diameter” of an object is a straight-line segment that passes through the center (or center axis) of an object. The line segment of the diameter is terminated at the perimeter or boundary of the object through which the line segment of the diameter runs.

As used herein, “front” indicates the side of an object that is closest to a forward direction of travel under normal use of the object or the side or part of an object that normally presents itself to view or that is normally used first. “Rear” or “back’ refers to the side that is opposite the front.

As used in this disclosure, a “frustum” is a portion of a solid that lies between two parallel planes that intersect with the solid.

As used in this disclosure, “horizontal” is a directional term that refers to a direction that is perpendicular to the local force of gravity. Unless specifically noted in this disclosure, the horizontal direction is always perpendicular to the vertical direction.

As used in this disclosure, the word “interior” is used as a relational term that implies that an object is located or contained within the boundary of a structure or a space.

As used herein, the words “invert”, “inverted”, or “inversion” refer to an object that has been turned inside out or upside down or to the act of turning an object inside out or upside down.

As used herein, “mate” refers to coupling at a predefined interface.

As used herein, “mounting hardware” refers to mechanical devices that are used to attach one object to another, including devices whose only purpose is to improve aesthetics. As non-limiting examples, mounting hardware may include screws, nuts, bolts, washers, crossbars, hooks, collars, nipples, standoffs, knobs, caps, plates, rails, and brackets.

As used in this disclosure, “orientation” refers to the positioning and/or angular alignment of a first object relative to a second object or relative to a reference position or reference direction.

As used in this disclosure, a “plate” is a flat, rigid object having at least one dimension that is of uniform thickness and is thinner than the other dimensions of the object. Plates often have a rectangular or disk like appearance. Plates may be made of any material, such as wood, plastic, or other material, that has sufficient structural strength to retain integrity as a load is placed upon the plate.

As used herein, the words “printed”, “marked”, and “marking” refer to a mark that has been made on an object. The process of making the mark may involve printing, lithography, thermal transfer, painting, embossing, molding, burning, silk-screening, drawing, etching, engraving, stamping, spraying of pigments, or other processes which result in the controlled change of coloration and/or shape of a surface.

As used in this disclosure, the term “rounded” refers to the replacement of an apex, vertex, or edge or brink of a structure with a (generally smooth) curvature wherein the concave portion of the curvature faces the interior or center of the structure.

As used in this disclosure, a “tool” is a device, an apparatus, or an instrument that is used to carry out an activity, operation, or procedure.

As used in this disclosure, “vertical” refers to a direction that is parallel to the local force of gravity. Unless specifically noted in this disclosure, the vertical direction is always perpendicular to horizontal.

The furniture assembly apparatus and system (hereinafter invention) comprises a furniture assembly apparatus for coupling furniture components and a furniture assembly system for assembling a piece of furniture from the furniture components utilizing the furniture assembly apparatus.

The furniture assembly apparatus comprises a first comb, a second comb, and a conical peg. The first comb may be coupled to a first furniture component and the second comb may be coupled to a second furniture component. The first comb may interlock with the second comb to couple the first furniture component to the second furniture component. The conical peg may be inserted into a plurality of peg apertures that align on both the first comb and the second comb to prevent the first comb from separating from the second comb. When interlocked properly the apparatus of a first comb and second comb connected with a conical peg serves to attach two or more sections of an item of furniture when assembling the item of furniture into a useable configuration.

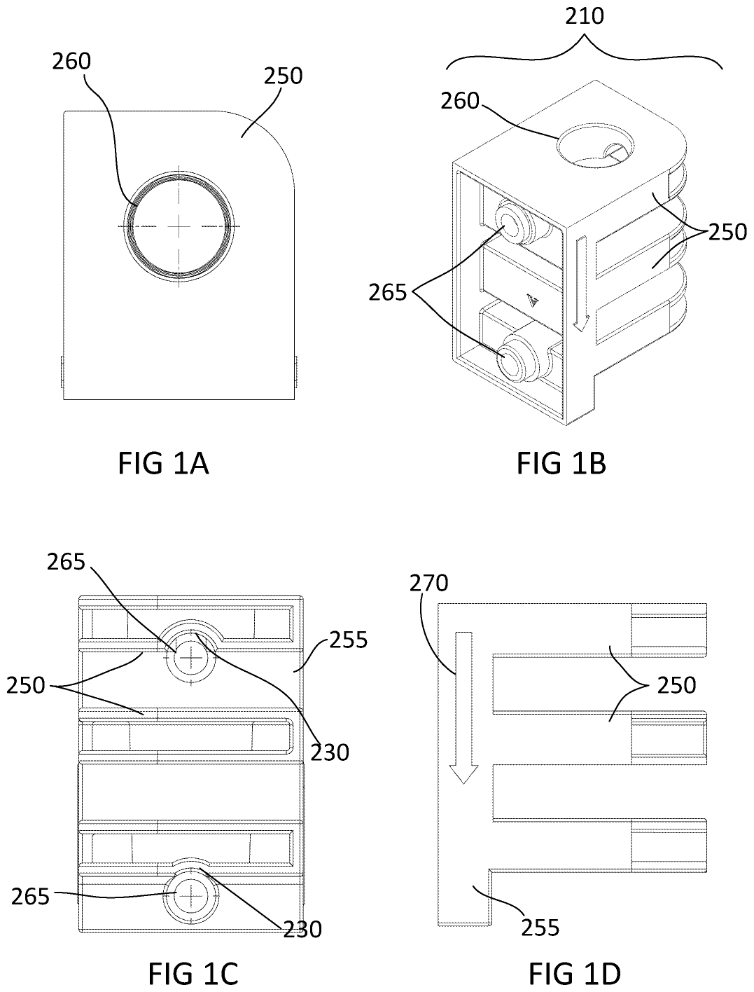

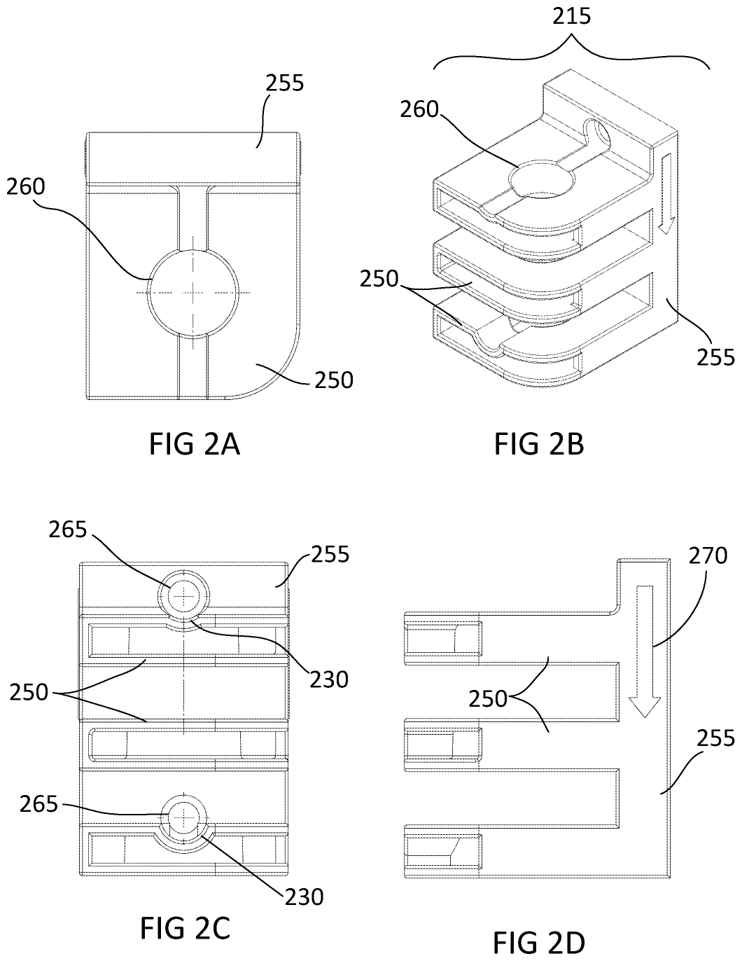

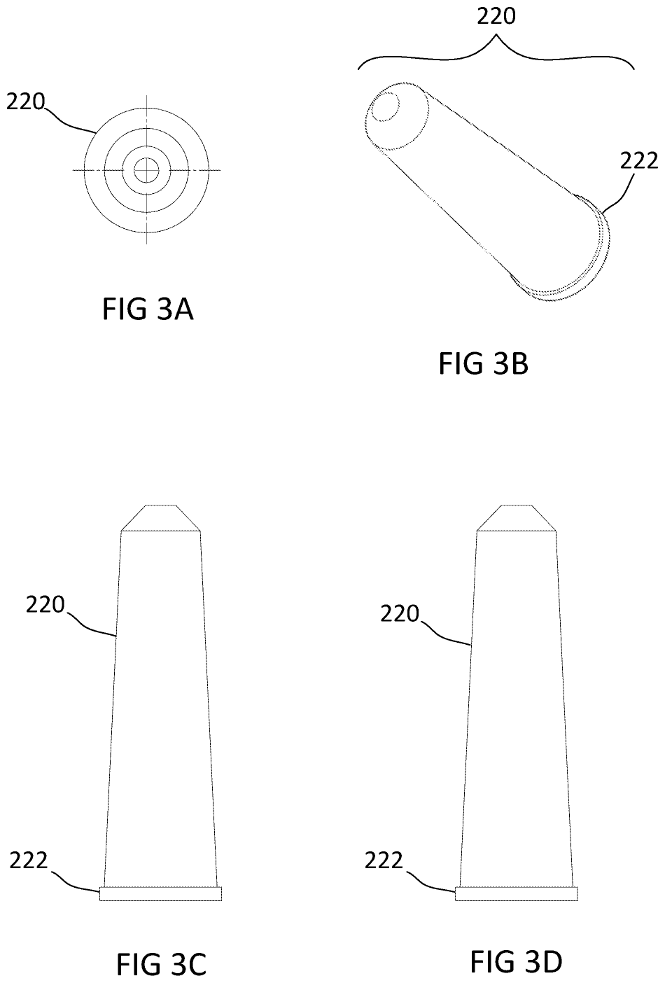

For descriptive purposes the first comb and the second comb will be described in an orientation as shown in FIG. 1, FIG. 2, and FIG. 3 with FIG. 1 illustrating the first comb, FIG. 2 illustrating the second comb, and FIG. 3 illustrating the conical peg. This orientation is not a limitation on the orientation of the first comb and the second comb while in use. An individual comb selected from the first comb and the second comb comprises a plurality of first plates and a second plate. The plurality of first plates may be oriented horizontally and parallel to each other. The second plate may be oriented vertically on one side of the plurality of first plates. The plurality of first plates may be coupled to the second plate along a common side of the plurality of first plates. For descriptive purposes, the side of the individual comb where the second plate is coupled is defined to be the rear of the individual comb.

The second plate may extend vertically above the plane of the uppermost of the plurality of first plates of the individual comb or below the plane of the lowest of the plurality of first plates of the individual comb. In some embodiments, the second plate may extend below the plane of the lowest of the plurality of first plates on the first comb and may extend vertically above the plane of the uppermost of the plurality of first plates on the second comb

In some embodiments, the plurality of first plates and the second plate may be a single component. As a non-limiting example, the plurality of first plates and the second plate may be a single part made from a mold.

The plurality of first plates may comprise the plurality of peg apertures passing from the top of each plate to the bottom of each plate at the center of each plate. All of the plurality of peg apertures on each plate may be vertically aligned with each other, meaning that the center of each of the plurality of peg apertures are arranged along a vertical line.

The plurality of peg apertures may comprise decreasing diameters at lower heights. Specifically, the diameter of the top of one of the plurality of peg apertures may be larger than the diameter of the bottom of the same hole. Additionally, the diameter of one of the plurality of peg apertures on an upper one of the plurality of first plates may be larger than the diameter of one of the plurality of peg apertures on a lower one of the plurality of first plates. The diameters of the plurality of peg apertures may decrease at lower levels such that the sides on the plurality of peg apertures on all of the plurality of first plates align and form an inverted conical shape.

The second plate may comprise a plurality of mounting apertures. The plurality of mounting apertures may be used to mount the individual comb to one of the furniture components. As non-limiting examples, the individual comb may be mounted to one of the furniture components using screws or bolts that pass through the individual comb and into one of the furniture components. The plurality of mounting apertures may be apertures that pass horizontally through the second plate. The plurality of mounting apertures may be located between the plurality of first plates.

The individual comb may comprise two or more tool gaps. The two or more tool gaps may be partial widenings of the spaces between the plurality of first plates. The two or more tool gaps may correspond to each of the plurality of mounting apertures. The two or more tool gaps may run horizontally from the plurality of mounting apertures at the rear of the individual comb to the front of the individual comb. The two or more tool gaps may allow a tool to access mounting hardware located at the plurality of mounting apertures. As a non-limiting example, the two or more tool gaps may be cylindrically-shaped gaps between the plurality of first plates at each location where the plurality of mounting apertures are located such that the two or more tool gaps align with the plurality of mounting apertures.

The individual comb may comprise one or more orientation markings. The one or more orientation markings may indicate an orientation of the individual comb and/or the conical peg. As non-limiting examples, the one or more orientation markings may be an arrow that may be painted, embossed, applied as a label, or otherwise made visible on the individual comb and which indicates the direction that the conical peg should be inserted.

In some embodiments, the diameters of the plurality of peg apertures on the first comb and the second comb may be different. Specifically, each of the plurality of peg apertures in the first comb may be larger than the diameter of the corresponding aperture in the plurality of peg apertures on the second comb such that when the first comb and the second comb are joined the draft angles of the plurality of peg apertures on the first comb and the draft angles of the plurality of peg apertures on the second comb are contiguous, aligned, and match the shape of the conical peg that may hold the first comb and the second comb together.

In some embodiments, the plurality of first plates on the individual comb may each comprise one or more corners that are rounded at each height. The rounded corners may clarify how the first comb and the second comb are intended to join and may direct and simplify the process of joining them. As a non-limiting example, the rounded corners may indicate that the first comb and the second comb should meet such that the rounded corners touch first. The rounded corners may further simplify the process for the first comb and the second comb to be coupled together by eliminating right angle corners that could jut out and interfere with the fit.

The conical peg may be a coupling pin having the shape of an inverted frustum of a cone. The conical peg may be inserted through the plurality of peg apertures of the first comb and the second comb when the first comb and the second comb are interlocked and may prevent the first comb and the second comb from pulling apart.

The first comb and the second comb may be used in pairs to join the furniture components together. In an embodiment, the piece of furniture may be shipped to a consumer in a disassembled state that has been optimized for the shipping process and may be assembled by the consumer. In another embodiment, the piece of furniture may be assembled into its final configuration by properly joining multiple pairs of first comb and second comb assemblies utilizing a conical peg for each pair of combs, securing the position of each component of the piece of furniture for use. Separating the first and second comb assemblies by removing the conical pegs also simplifies the disassembly of each piece of furniture so equipped.

As a non-limiting example, a sofa may be shipped with a sofa back, a sofa front rail, a sofa left arm, and a sofa right arm separated from each other and possibly arriving in different containers. The sofa back may comprise one or more of the first combs and the sofa left arm may comprise one or more of the second combs. One or more the first combs on the sofa back may be placed such that they align with one or more the second combs on the sofa left arm when the sofa back and the sofa left arm are in the proper relative position and alignment. The consumer may quickly and easily couple the sofa back to the sofa left arm by aligning the first combs with the second combs and inserting the conical pegs.

As used above, the phrase “optimized for the shipping process” may refer to, among other things, a situation where the piece of furniture has been disassembled and the furniture components have been placed in containers in a way that fits a standard side container, reduces shipping cost, reduces package weight, simplifies assembly, or combinations thereof.

The first comb and the second comb may be used during the shipping process and during final assembly after receipt by the user to hold the furniture components together. Specifically, the furniture components, including ones that are not intended to be coupled to each other when the piece of furniture is complete, may be coupled together for shipping if they are a comparable size or it would otherwise be advantageous to ship them in the same container. As a non-limiting example, the sofa left arm and the sofa right arm may be a comparable size and may therefore be packaged together by placing the interior side of the sofa right arm against the interior side of the sofa right arm, aligning the first combs and the second combs on both components, and inserting the conical pegs to hold the sofa left arm and the sofa right arm together.

As used herein, any location where the first comb couples to the second comb with the conical peg may be referred to as a position. The positions may be numbered, lettered, or otherwise designated in instructions for assembling the piece of furniture.

The furniture assembly system comprises an article of furniture that may be delivered as a plurality of furniture components where at least two of the furniture components may be joined to each other using one or more instances of the furniture assembly apparatus. As non-limiting examples, the article of furniture may be a sofa and the furniture components may comprise a sofa back, a sofa right arm, a sofa left arm, and a sofa front rail. The sofa back, sofa right arm, sofa left arm, and sofa front rail may be coupled to each other using a plurality of furniture assembly apparatuses to form a basic structure of the sofa. The basic structure of the sofa may be combined with other components such as a seat deck, cushions, and pillows to complete the sofa. The furniture assembly apparatuses may be positioned on the furniture components where they are operable to both couple furniture components to form the finished sofa and also to couple the furniture components for shipping. The furniture components that are coupled for assemble may be different from the components that are coupled for shipping.

Turning now to FIGS. 1A, 1B, 1C, and 1D, these figures present top (1A), isometric (1B), front (1C), and side (1D) views of the first comb 210. The plurality of first plates 250 extend horizontally and parallel to each other away from the second plate 255. A plurality of peg apertures 260 extended vertically down through the plurality of first plates 250. The plurality of mounting apertures 265 are exposed on the second plate 255 for the purpose of coupling the first comb 210 to the article of furniture. The two or more tool gaps 230 provide access for a tool while coupling the first comb 210 to the article of furniture. The one or more orientation markings 270 indicate a direction for insertion of the conical peg into the first comb.

Turning now to FIGS. 2A, 2B, 2C, and 2D, these figures present top (2A), isometric (2B), front (2C), and side (2D) views of the second comb 215. The plurality of first plates 250 extend horizontally and parallel to each other away from the second plate 255. The plurality of peg apertures 260 extended vertically down through the plurality of first plates 250. The plurality of mounting apertures 265 are exposed on the second plate 255 for the purpose of coupling the second comb 215 to the article of furniture. The two or more tool gaps 230 provide access for a tool while coupling the second comb 215 to the article of furniture. The one or more orientation markings 270 indicate a direction for insertion of the conical peg into the first comb.

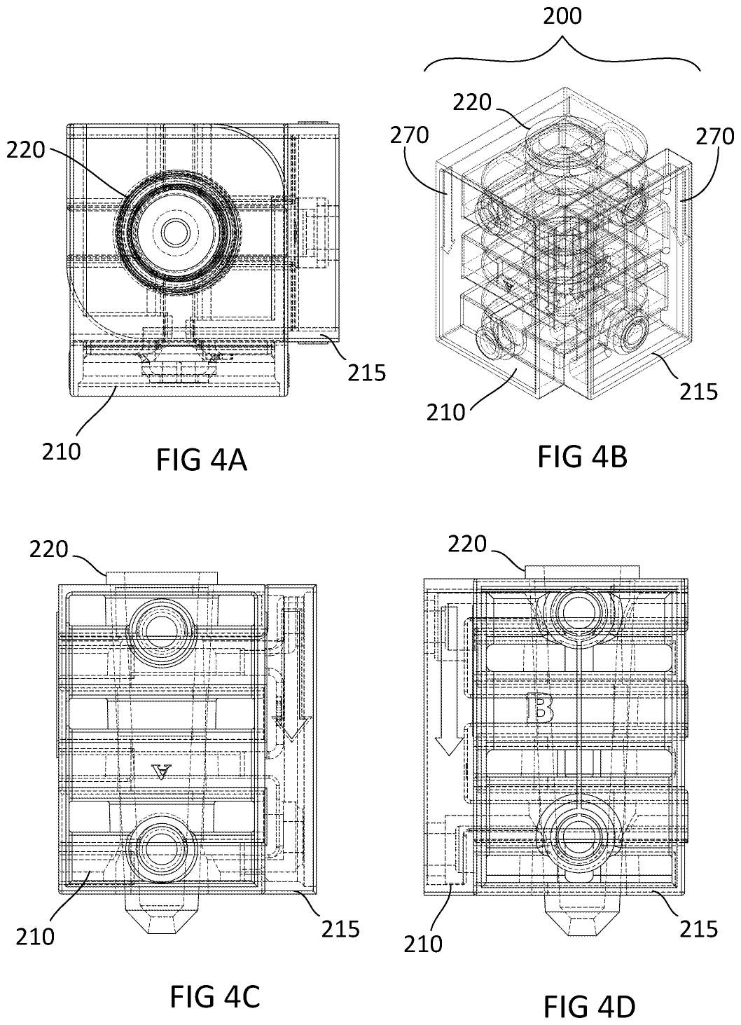

When the one or more orientation markings 270 on the first comb 210 and the second comb 215 are aligned in the same direction, the first comb 210 and the second comb 215 may be joined to form a type of ‘open through mortise and tenon joint’ as such in FIG. 4.

Turning now to FIGS. 3A, 3B, 3C, and 3D, these figures present top (3A), isometric (3B), front (3C), and side (3D) views of the conical peg 220. The conical peg 220 is tapered to fit the plurality of peg apertures of the first comb and the second comb. The conical peg 220 may be inserted narrow end first into the first comb and the second comb when the first plates of the first comb and the first plates of the second comb are interleaved. Insertion of the conical peg 220 into the first comb and the second comb may be stopped by the insertion limiter 222.

Turning now to FIGS. 4A, 4B, 4C, and 4D, these figures present top (4A), isometric (4B), front (4C), and side (4D) X-ray views of the furniture assembly apparatus 200 when coupled. The first plates of the first comb 210 and of the second comb 215 are interleaved with the one or more orientation markings 270 of both the first comb 210 and the second comb 215 aligned in the same direction. The conical peg 220 may be inserted through the plurality of peg apertures in the direction of the one or more orientation markings 270 to prevent the first comb 210 and the second comb 215 from separating.

The interleaving of the first comb 210 and the second comb 215 are not limited to the orientations shown. The second comb may be rotated around the conical peg 220 by up to 180 degrees relative to the second comb. As non-limiting examples, the second plates of the first comb 210 and the second comb 215 may be oriented to be at right angles to each other, may be oriented to be parallel to each other, or may assume angular orientations between being perpendicular and being parallel.

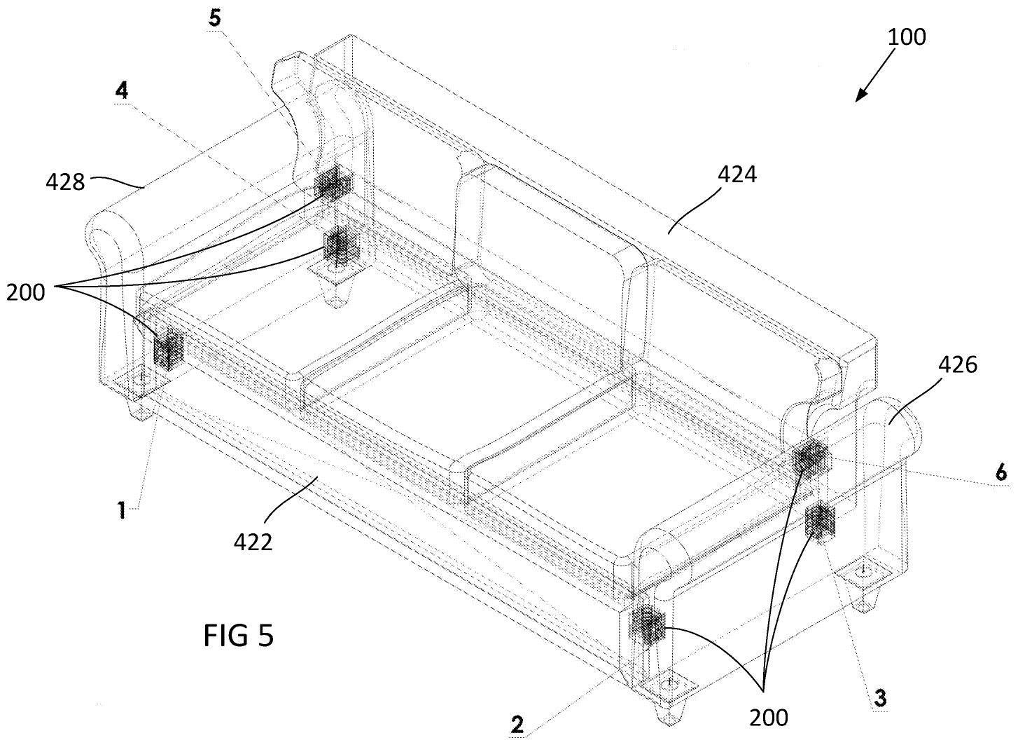

Turning now to FIG. 5, this figure presents a view of the sofa assembled in accordance with the furniture assembly system. The positions and orientations of the furniture assembly apparatuses 200 are shown and are numbered 1 through 6. The sofa front rail 422 may be coupled to the sofa right arm 428 at position 1 and to the sofa left arm 426 at position 2. The sofa back 424 may be coupled to the sofa left arm 426 at positions 3 and 6 and to the sofa right arm 428 at positions 4 and 5. The seating deck, cushions, and seat backs may then be added to this structure.

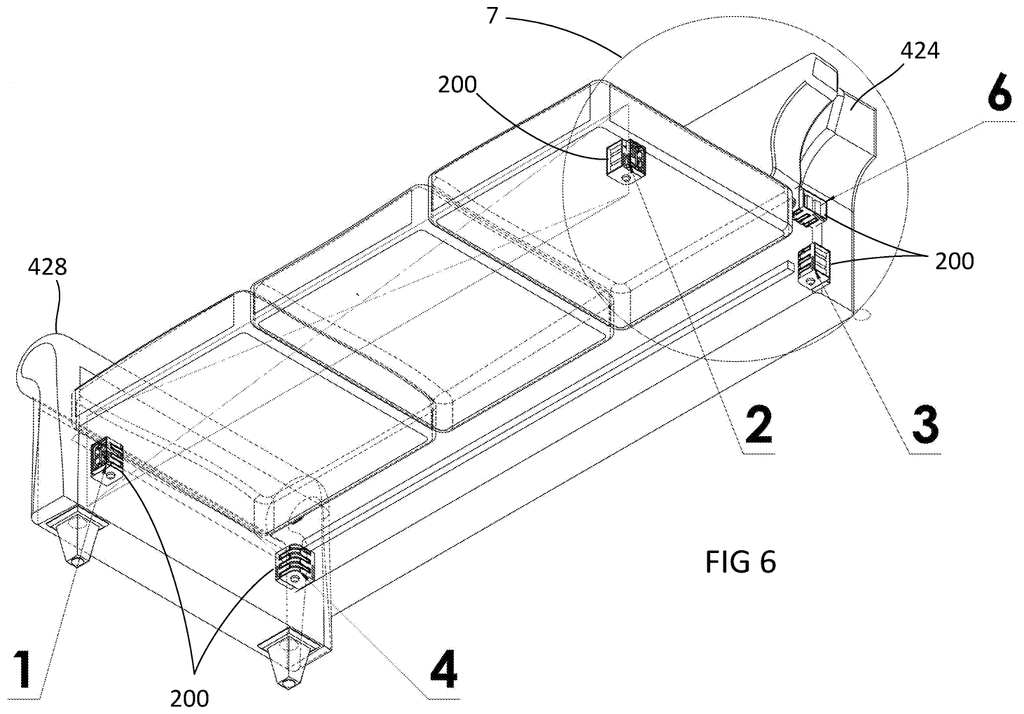

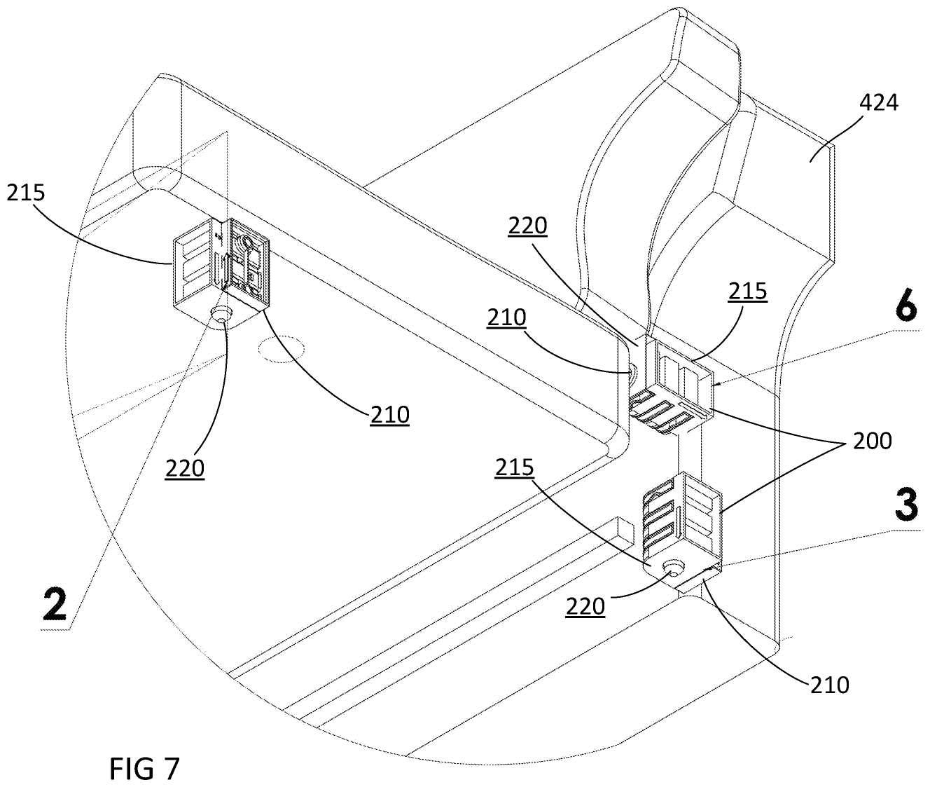

Turning now to FIG. 6, this figure presents the sofa of FIG. 5 in a partially deconstructed state, showing the sofa right arm 428 and sofa back 424 and positions 1, 2, 3, 4, and 6 of the furniture assembly apparatus 200. The view is shown from a location below and to the left of the sofa. The sofa back 424 and the sofa right arm 428 are shown. The right side of FIG. 6 is explained in more detail in FIG. 7.

Turning now to FIG. 7, this figure presents details of the sofa illustrating the portion of FIG. 6 that is designated as 7. At each position where a furniture assembly apparatus 200 is used, the first comb 210 is mounted onto one furniture component, the second comb 215 is mounted onto a second furniture component, and a conical peg 220 is inserted into the interleaved first comb and second comb to couple the furniture assembly apparatus 200.

It can be seen that the furniture assembly apparatus 200 at position 3 is oriented such that the conical peg 220 may be inserted vertically from the top of the sofa whereas the furniture assembly apparatus 200 at position 6 is oriented such that the conical peg 220 may be inserted horizontally from the front of the sofa.

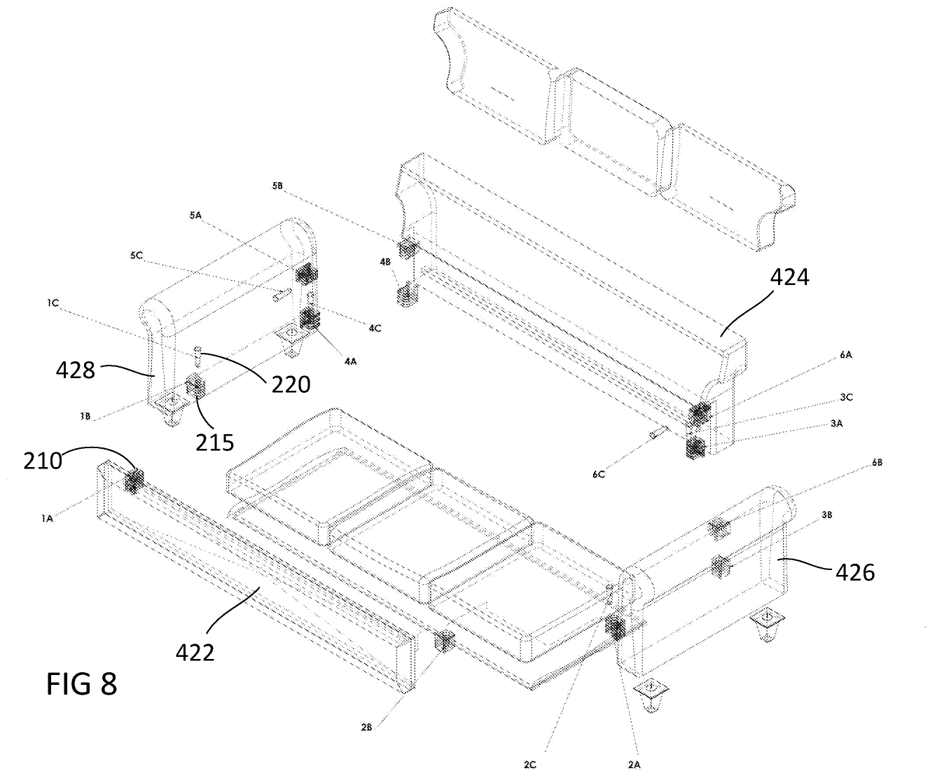

Turning now to FIG. 8, this figure presents an exploded view of component pieces of the sofa including the sofa back 424, the sofa front rail 422, the sofa left arm 426, the sofa right arm 428, cushions, legs, seat deck, the first combs 210, the second combs 215, and the conical pegs 220.

In a non-limiting example, this figure presents an assembly of the sofa where the sofa front rail 422 couples to the sofa right arm 428 using the furniture assembly apparatus 200 at position 1, the sofa front rail 422 couples to the sofa left arm 426 using the furniture assembly apparatus 200 at position 2, the sofa right arm 428 couples to the sofa back 424 using the furniture assembly apparatuses 200 at position 4 and position 5, and the sofa left arm 426 couples to the sofa back 424 using the furniture assembly apparatuses 200 at position 3 and position 6.

The figure also illustrates the placement of the first comb 210 and the second comb 215 for each of the positions where the furniture assembly apparatuses 200 are located. The first comb 210 may be placed opposite the second comb 215 so that components may be mated to each other for shipping. As a non-limiting example, comb 1A is opposite comb 4B and comb 2B is opposite comb 3A so that the sofa front rail 422 may be mated to the sofa back 424 for shipping. As a further non-limiting example, comb 1B is opposite comb 2A, comb 4A is opposite comb 3B, and comb 5A is opposite comb 6B so that the sofa left arm 426 may be mated to the sofa right arm 428 for shipping.

While certain illustrative embodiments have been described, it is evident that many alternatives, modifications, permutations and variations will become apparent to those skilled in the art in light of the foregoing description.

What is claimed is:

1. A furniture assembly system comprising:
an article of furniture comprising a plurality of furniture components and
one or more furniture assembly apparatuses;
where at least a first furniture component selected from the plurality of furniture components comprises a first comb of the one or more furniture assembly apparatuses;
where at least a second furniture component selected from the plurality of furniture components comprises a second comb of the one or more furniture assembly apparatuses;
where the first furniture component is positioned such that the first comb of the first furniture component interleaves the second comb of the second furniture component;
where a conical peg of the one or more furniture assembly apparatuses is inserted through the first comb and through the second comb via a plurality of peg apertures.

2. The furniture assembly system of claim 1,
where a first subset of the plurality of furniture components are coupled via the one or more furniture assembly apparatuses to complete the assembly of the article of furniture;
where a second subset of the plurality of furniture components are coupled via the one or more furniture assembly apparatuses to package and ship the article of furniture;
where the first subset of the plurality of furniture components is different from the second subset of the plurality of furniture components.

3. The furniture assembly system of claim 1, further comprising:
a furniture assembly apparatus comprising:
a first comb,
a second comb, and
a conical peg;
where an individual comb selected from the first comb and the second comb comprises a plurality of first plates that are parallel to each other;
where the individual comb comprises a second plate that is perpendicular to the plurality of first plates;
where the plurality of first plates are coupled to the second plate
where the first comb is coupled to a first furniture component;
where the second comb is coupled to a second furniture component
where the plurality of first plates from the first comb and the plurality of first plates from the second comb are interleaved,
where the conical peg is inserted through a plurality of peg apertures located in the plurality of first plates of both the first comb and the second comb to prevent the first comb and the second comb from separating.

4. The furniture assembly system of claim 3,
where the second plate comprises a plurality of mounting apertures;
where the plurality of mounting apertures are operable to mount the individual comb to a furniture component;
where the plurality of mounting apertures are located between the plurality of first plates.

5. The furniture assembly system of claim 3,
where the individual comb comprises two or more tool gaps;
where the two or more tool gaps are widenings of the spaces between the plurality of first plates;
where the two or more tool gaps correspond to each of the plurality of mounting apertures;
where the two or more tool gaps allow a tool to access mounting hardware located at the plurality of mounting apertures.

6. The furniture assembly system of claim 3,
where the conical peg comprises an insertion limiter to limit the distance that the conical peg is inserted into the first comb and the second comb.

7. The furniture assembly system of claim 1, further comprising:
attaching two or more components of an item of furniture together by connecting a plurality of furniture assembly apparatuses in a proper orientation to complete the assembly of an item of furniture,
where the assembled item of furniture is held together securely during use by the plurality of furniture assembly apparatuses.
